(19) United States
(12) Patent Application Publication
(10) Pub. No.: US 2023/0064562 A1
(43) Pub. Date: Mar. 2, 2023

(54) SYSTEM AND METHOD FOR PROVIDING AN ACCOUNTING PLATFORM

(71) Applicant: Aladdin Connolly, Worcester, MA (US)

(72) Inventor: Aladdin Connolly, Worcester, MA (US)

(21) Appl. No.: 17/843,955

(22) Filed: Jun. 17, 2022

Related U.S. Application Data
(60) Provisional application No. 63/211,656, filed on Jun. 17, 2021.

(51) Int. Cl. G06Q 40/00

(52) U.S. Cl. CPC G06Q 40/123

(57) ABSTRACT

A system for providing an accounting platform, the system comprising at least one user computing device in operable connection with a user network. An application server is in operable communication with the user network to host an application system for providing a system for providing an accounting platform. The application system includes a user interface module for providing access to the application system through the client computing device, accounting computing device, or subcontractor computing device. The user interface module is in operable communication with a user database for storing user information and a document database for storing tax documents. A document module permits the filling and processing of the one or more tax documents and a portal module permits the creation of a user portal for interacting with the system.

### CROSS-REFERENCE TO RELATED APPLICATIONS

The present application claims priority to U.S. Provisional Application No. 63/211,656 filed Jun. 17, 2021, titled “SYSTEM AND METHOD FOR PROVIDING AN ACCOUNTING PLATFORM,” which is hereby incorporated by reference in its entirety.

### TECHNICAL FIELD

The embodiments generally relate to computerized systems for providing accounting systems and more specifically relates to computerized system for aiding in the processing of tax documents.

### BACKGROUND

The Internet has allowed many individuals and businesses to conduct business online, such as by performing various transactions, trading goods and services, etc. Along these lines, the filing of tax returns electronically has increased in number resulting in the advance of Internet-based tax preparation services.

Accountants may also use tax preparation software to prepare and file tax returns for their clients. This involves receiving various tax documents and inputting the information into the software interface. For clients who report various types of income other than wages, salaries, and tips (for which a Form W-2 is used) one or more Form 1099's are required. This form is used by independent contractors, rental property income, income from interest and dividends, sales proceeds, and other miscellaneous income. These forms can be tedious for accountants to manage, and more efficient preparation solutions are not readily available in the arts.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments provided herein relate to a system for providing an accounting platform, the system comprising at least one user computing device in operable connection with a user network. An application server is in operable communication with the user network to host an application system for providing a system for providing an accounting platform. The application system includes a user interface module for providing access to the application system through the client computing device, accounting computing device, or subcontractor computing device. The user interface module is in operable communication with a user database for storing user information and a document database for storing tax documents. A document module permits the filling and processing of the one or more tax documents and a portal module permits the creation of a user portal for interacting with the system.

In use, the accountant sets up a portal by adding the client's name, email, EIN and other tax and/or contact information. The communication module then transmits an alert, notification, or other communication to the client to notify the client that their portal is available. The client may then complete the portal set-up process by adding subcontractor information and requesting a Form W-9 from the subcontractors. The subcontractor may then fill out the Form W-9 and transmit the Form W-9 back to the client and/or accountant for processing. Information from the W-9 is then populated, via the system, to the Form 1099.

In one aspect, the system includes a communications module to permit the communication between the client computing device, the accountant computing device, and the subcontractor computing device.

In one aspect, the communications module transmits a communication to the client once the portal is set-up by the accountant.

In one aspect, the communications module transmits a request to complete a Form W-9.

In one aspect, the document module permits the automated filling of a Form 1099 from the completed Form W-9.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of a computing system, according to some embodiments;

FIG. 2 illustrates a block diagram of a computing system and an application program, according to some embodiments;

FIG. 3 illustrates a block diagram of the application program, according to some embodiments;

FIG. 4 illustrates a webpage landing diagram of the application program, according to some embodiments;

FIG. 5 illustrates a webpage responsive diagram of the application program, according to some embodiments;

FIG. 6 illustrates a webpage sign up diagram of the application program, according to some embodiments;

FIG. 7 illustrates a webpage sign in diagram of the application program, according to some embodiments;

FIG. 8 illustrates a webpage about us diagram of the application program, according to some embodiments;

FIG. 9 illustrates a webpage FAQ diagram of the application program, according to some embodiments;

FIG. 10 illustrates a webpage calculator diagram of the application program, according to some embodiments;

FIG. 11 illustrates a mobile device calculator diagram of the application program, according to some embodiments;

FIG. 12 illustrates a webpage onboarding diagram of the application program, according to some embodiments;

FIG. 13 illustrates a webpage video diagram of the application program, according to some embodiments;

FIG. 14 illustrates a webpage call to action diagram of the application program, according to some embodiments;

FIG. 15 illustrates a webpage empty dashboard diagram of the application program, according to some embodiments; and

FIG. 16 illustrates a webpage filed dashboard diagram of the application program, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, and/or computer program product at any possible technical detail level of integration. A computer program product can include, among other things, a computer-readable storage medium having computer-readable program instructions thereon for causing a processor to carry out aspects of the present disclosure.

In general, the embodiments described herein relate to a system and method for tax document preparation which may be utilized by an accountant to interact with clients, receive tax information, communicate with subcontractors, and process tax documents. The system allows for the accountant to set up a portal to allow for client communication. The client may transmit tax-related information, personal information, subcontractor information, and the like. In such, the system provides an efficient means for communicating with subcontractors to receive a Form W-9 needed for accurately filling a 1099 Form. One skilled in the arts will readily understand that while the Form W-9 and the Form 1099 are utilized as exemplary embodiments, the system may be readily applied to other tax documents and may be especially useful for documents which require various parties to submit information.

As used herein, the term “tax information” is used to describe any information commonly included on a tax document including an Employer Identification Number (EIN), Social Security Number (SSN), salary information, wages, tips, payments received, etc.

As used herein, the term “personal information” may be used to describe personal information submitted by a client, an accountant, a subcontractor, or other user of the system. For example, the personal information may include contact information, addresses, etc.

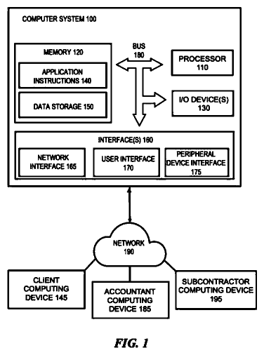

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., C, C++, C#, JAVA, JAVASCRIPT, PERL, etc.).

In this disclosure, terms “store,” “storage,” “data store,” “data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include connection or coupling with a client computing device 145, an accountant computing device 185 and a subcontractor computing device 195, each in communication via the network 190. The client computing device 145 may be utilized by clients of the accountant to submit tax information, personal information, and communicate with the other users of the system. The accountant computing device 185 is utilized by an accountant who may manage clients, transmit information, or prepare and process tax documents. The subcontractor computing device 195 may be utilized by subcontractors who receive information from the client and/or accountant, and to prepare and transmit tax documents.

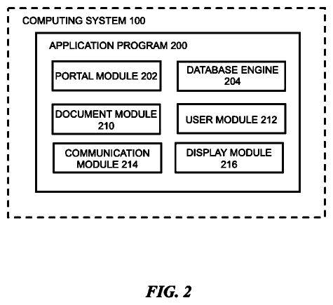

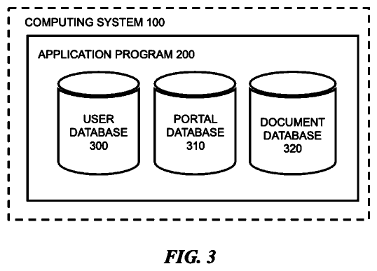

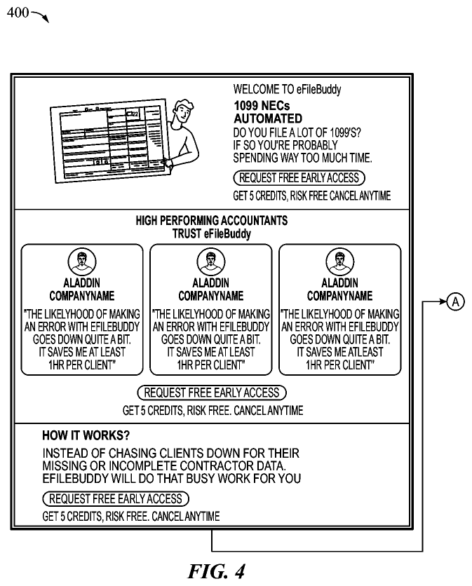

FIGS. 2 and 3 illustrate an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200, and FIG. 3 is a block diagram showing the various databases utilized by the various modules.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a portal module 202, a database engine 204, a document module 210, a user module 212, a communication module 214, and a display module 216.

In some embodiments, a portal module 202 permits the creation of a client portal which via the user interface. The accountant and/or the client may create the portal by inputting the client's personal information (e.g., their name, contact information, EIN, etc.). The client may be notified, via the communication module 214, of the generation of the portal. The client may be tasked with completing the portal set-up process, such as by adding contractors and their associated information (e.g., email addresses, names, etc.). The portal module 202 then permits the client to request the Form W-9 from one or more subcontractors. The subcontractors may then be permitted to fill in the Form W-9 and return the completed W-9 to the client and/or the accountant via the portal.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

In some embodiments, the document module 210 is configured to process and transmit tax documents within the system via the network. The document module 210 may aid in the automatic processing and filling of the various tax documents. For example, the document module 210 transmits the Form W-9 between the subcontractor, client, and accountant.

In some embodiments, the user module 212 facilitates the creation of a user account for the application system. In such, the user account may be associated with an accountant, client, and/or subcontractor. The user module 212 may associate various permissions with each user.

In some embodiments, the communication module 214 is configured for receiving, processing, and transmitting a user command and/or one or more data streams. In such embodiments, the communication module 214 performs communication functions between various devices, including the client computing device 145, the accountant computing device 185, and a subcontractor computing device 195. In some embodiments, the communication module 214 is configured to allow one or more users of the system, including a third-party, to communicate with one another. In some embodiments, the communications module 214 is configured to maintain one or more communication sessions with one or more servers, the accountant computing device 185, and/or one or more client computing device(s) 195.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored.

The display module 216 is operable to provide a tax document transmission and preparation platform which can be used by accountants, clients, and subcontractors alike to transmit, prepare, process, and otherwise interact with tax documents including the Form 1099 and the Form W-9.

FIG. 3 illustrates the computing system 100 in operable communication with the application program 200 having a plurality of databases in communication thereto. A user database 300 is operable to store user information such as user preferences, tax information, personal information, payment information (for the payment and processing of fees, and the like. The portal database 310 stores portal information including the portal display preferences, portal settings, and information provided by the portal to the client, accountant, and/or the subcontractor.

The document database 320 stores tax documents and other documents utilized by the system.

In use, the accountant sets up a portal by adding the client's name, email, EIN and other tax and/or contact information. The communication module then transmits an alert, notification, or other communication to the client to notify the client that their portal is available. The client may then complete the portal set-up process by adding subcontractor information and requesting a Form W-9 from the subcontractors. The subcontractor may then fill out the Form W-9 and transmit the Form W-9 back to the client and/or accountant for processing. Information from the W-9 is then populated, via the system, to the Form 1099.

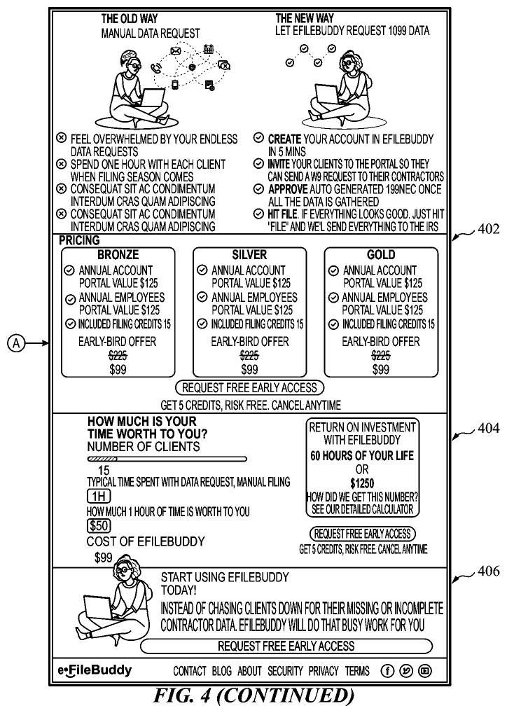

FIG. 4 illustrates a webpage landing diagram 400 of the application program, according to some embodiments. As shown in the example embodiment, initial information can include a brief description of how the program works, testimonials, and comparisons of existing methods and systems and the instant methods and systems. Pricing section 402, can include pricing information for one or more packages and can include one or more user selectable buttons that will cause the system to display more information to the user about the selection. Value of time section 404 can include one or more adjustable bars, fields, radio buttons, or other user selectable and modifiable data entry mechanisms. Here, the user can enter information such as their hourly rate or charge per document or documents, amount of time to prepare documents, number of clients, and/or other information and the system can use this information to calculate and display an expected amount of time and/or money savings for the user. As an example, a user who has 15 clients and typically spends one hour per client at the cost of $50 per hour might require a particular amount of time to prepare and file all documents. Using the system for a particular fee might save that user sixty hours and/or $1250, as displayed by the system after the system calculates the amount using the inputted values. A system signup section 406 can allow users to sign up for the system by selecting the appropriate button.

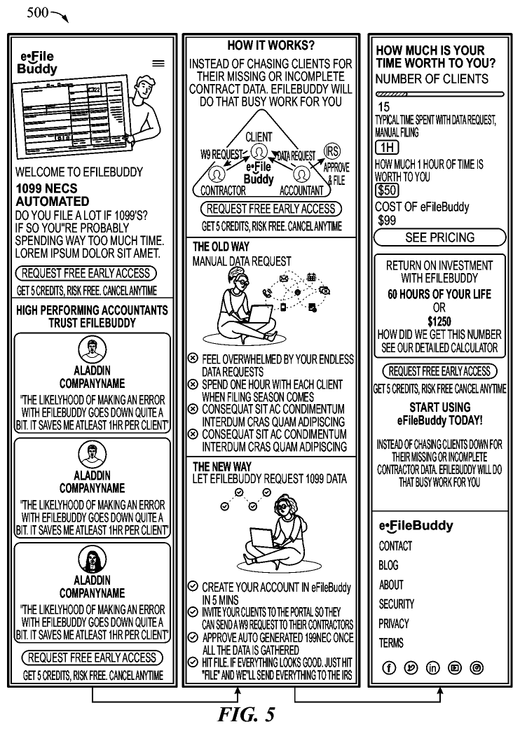

FIG. 5 illustrates a webpage responsive diagram 500 of the application program, according to some embodiments. As shown in the example embodiment, this functionality can be similar to the functionality shown and described with respect to FIG. 4.

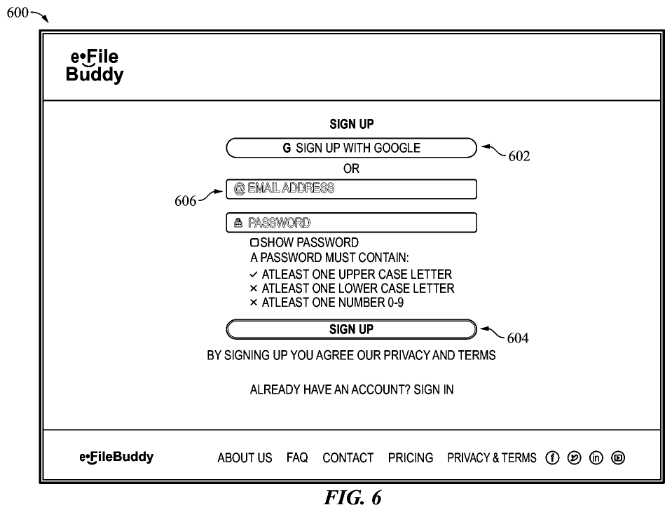

FIG. 6 illustrates a webpage sign up diagram 600 of the application program, according to some embodiments. As shown in the example embodiment, a sign-up screen can include a third-party sign in button 602 that allows users to link sign in information and/or credentials for accounts from third party platforms (e.g. Google® accounts or others). Alternatively or additionally, users are also able to create or enter sign up information such as a username and password in fields 606 to create a new account. Once entered, the user can select a sign-up button 604 to progress to the next screen in the system.

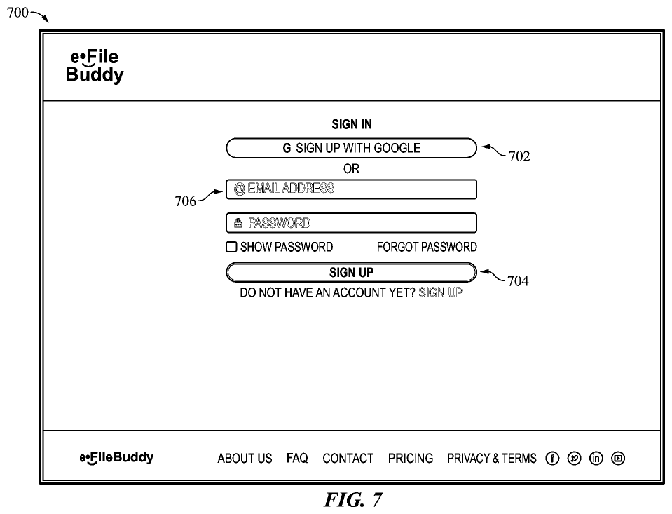

FIG. 7 illustrates a webpage sign in diagram 700 of the application program, according to some embodiments. As shown in the example embodiment, if a user has previously created an account with the system, they can login using their previously selected third-party account by selecting a third-party sign in button 702 that allows users to link sign in information and/or credentials for accounts from third party platforms (e.g. Google® accounts or others). Alternatively or additionally, users are also able to enter sign in information such as a username and password in fields 706 to access their previously created account. Once the username and password are entered, the user can select a sign-in button 704 to progress to the next screen in the system.

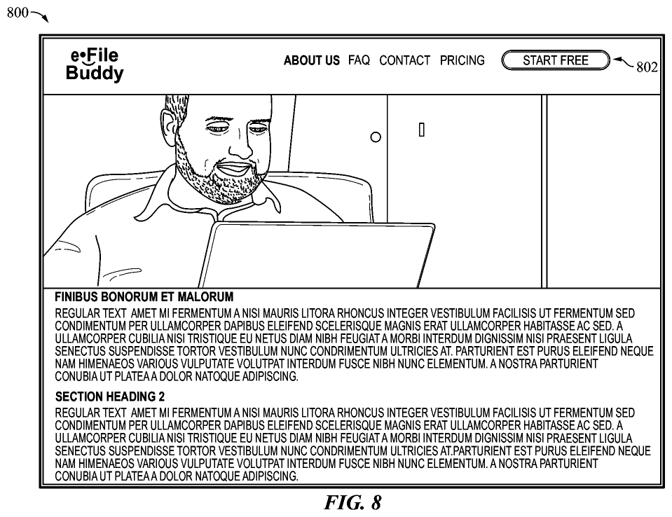

FIG. 8 illustrates a webpage about us diagram 800 of the application program, according to some embodiments. As shown in the example embodiment, if a user has navigated to an about us page, the system can display information about the system, including how the system works, who the system backers are, what advantages the system provides over existing alternatives, and/or other information. As shown, user selectable buttons 802 in a top or other menu can allow users to navigate through different portions of the platform, including an about us, FAQ, contact, pricing, and signup portion.

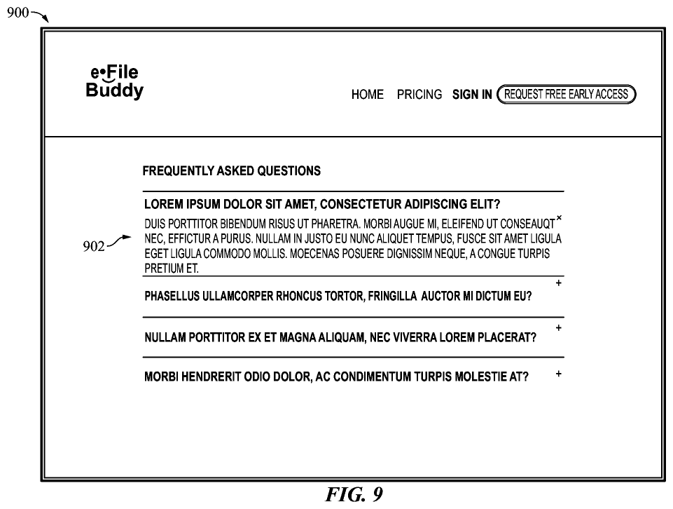

FIG. 9 illustrates a webpage FAQ diagram 900 of the application program, according to some embodiments. As shown in the example embodiment, users can view one or more FAQs as displayed by the system. In some embodiments, users can interact with an expand and/or contract button to view answers and/or additional information about their selected FAQ.

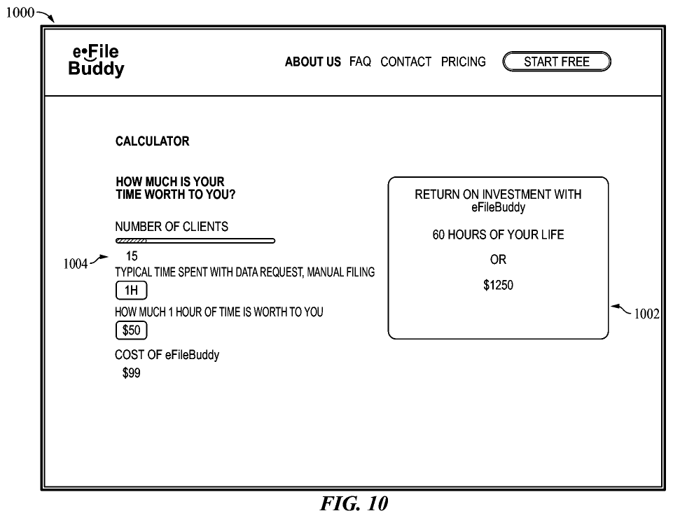

FIG. 10 illustrates a webpage calculator diagram 1000 of the application program, according to some embodiments. A calculator can include one or more adjustable bars, fields, radio buttons, or other user selectable and modifiable data entry mechanisms 1004. Here, the user can enter information such as their hourly rate or charge per document or documents, amount of time to prepare documents, number of clients, and/or other information and the system can use this information to calculate and display an expected amount of time and/or money savings for the user. As an example, a user who has 15 clients and typically spends one hour per client at the cost of $50 per hour might require a particular amount of time to prepare and file all documents. The system can also display the cost to sign up for the platform (e.g. $99). Using the system for a particular fee might save that user sixty hours and/or $1250, as displayed in the RoI section 1002 by the system after the system calculates the amount using the inputted values.

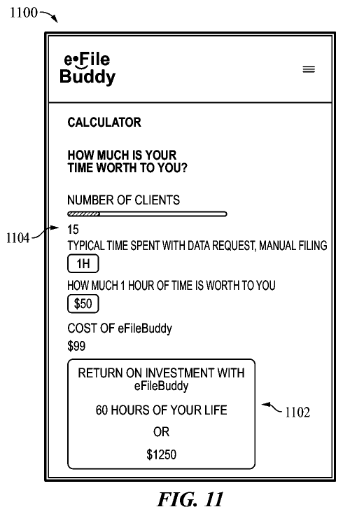

FIG. 11 illustrates a mobile device calculator diagram 100 of the application program, according to some embodiments. As shown in the example embodiment, elements 1102 and 1104 correspond with 1002 and 1004 respectively of FIG. 10 and their corresponding descriptions herein.

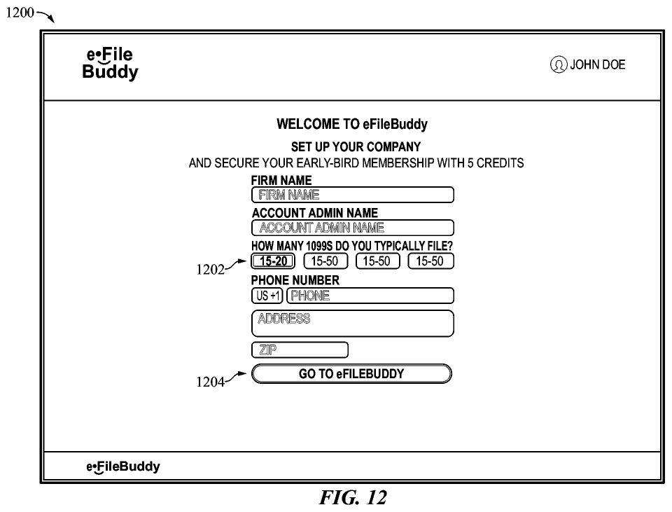

FIG. 12 illustrates a webpage onboarding diagram 1200 of the application program, according to some embodiments. As shown in the example embodiment, a user is able to enter or select information in various fields 1202 in order to onboard their business with the system. Here, a company's name, account administrator's name, how many documents will typically be filed (for instance in ranges or specific estimates), phone number, email address, physical address, and/or other contact information can be included. Once entered, the user can confirm by selecting button 1204 and move to the next screen.

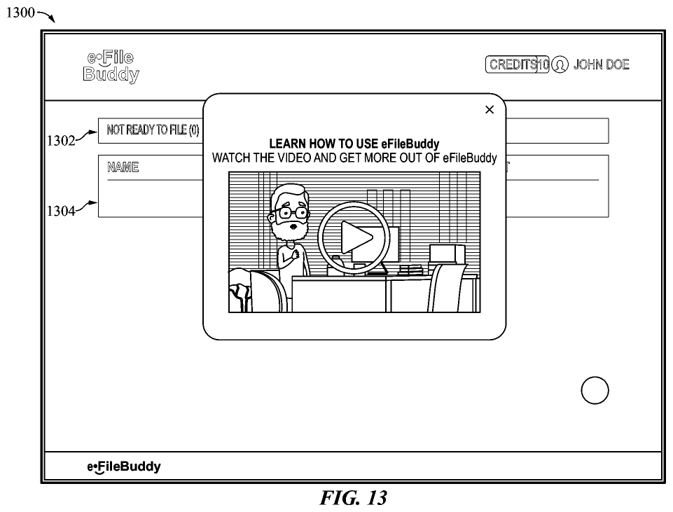

FIG. 13 illustrates a webpage video diagram 1300 of the application program, according to some embodiments. As shown in the example embodiment, when displaying a video that a user has selected the screen may become slightly opaque in the background and the video can be displayed in a smaller window in the foreground with user selectable control buttons, such as play, pause, stop, reverse, fast forward, or others.

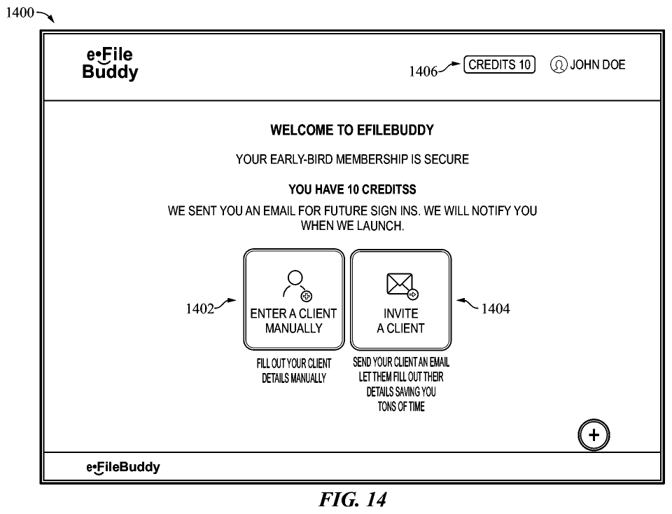

FIG. 14 illustrates a webpage call to action diagram 1400 of the application program, according to some embodiments. As shown in the example embodiment, users can enter client information manually by selecting button 1402 which will take the user to manual entry screen(s). This can be useful for existing clients who do not wish to enter their own information and/or for users who are providing the service for their client(s). Alternatively or additionally, users can invite clients to sign up for the platform and fill out their own information by selecting button 1404.

Here, users will save time by allowing clients to enter their own information. Also shown is a credit tracker that displays to a user how many credits they have with the system. Credits can be used on a per client basis, for groups of clients, or in other fashions in different embodiments.

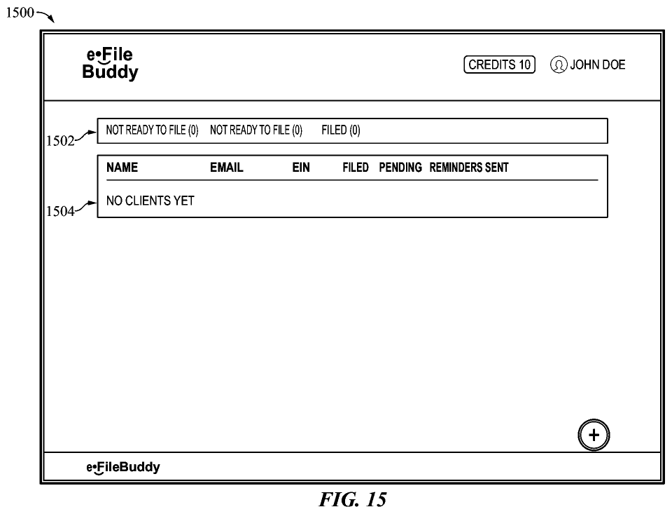

FIG. 15 illustrates a webpage empty dashboard diagram 1500 of the application program, according to some embodiments. As shown in the example embodiment, a status bar can display and have selectable sections regarding the quantity of documents that are ready to file, not ready to file, filed, or other metrics (e.g. in progress, waiting for feedback/documents, pending approval, and others). List 1504 can display information regarding each client including contact information, status, reminder information, and others.

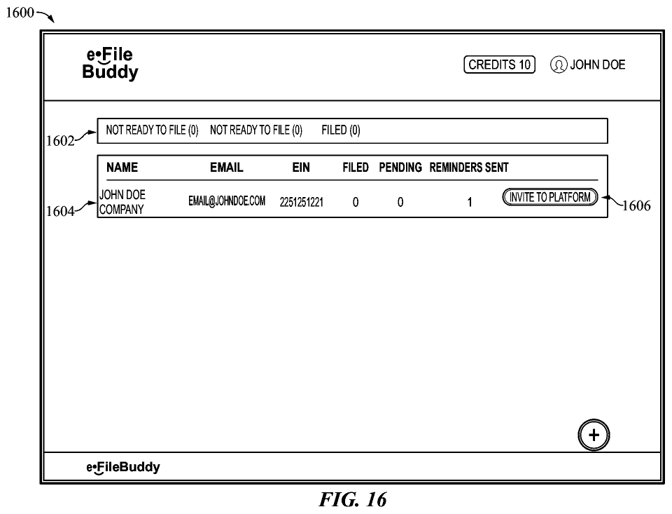

FIG. 16 illustrates a webpage filed dashboard diagram 1600 of the application program, according to some embodiments. As shown in the example embodiment, elements 1602 and 1604 correspond with 1502 and 1504 respectively of FIG. 15 and their corresponding descriptions herein. As shown, a company name, email, EIN, filed, pending, and reminders sent status and quantity are included. Selectable button 1606 allows the user to invite the client to the platform and will send a note to the client's previously entered contact information and/or allow the user to enter the client's contact information upon selection.

In various embodiments the system can provide one or more layers of data gathering. At some or all layers of data gathering, the system can auto populate from prior levels and into next levels upon approval at the existing layer.

In embodiments with client information entry, the system can provide for the client to send and/or enter their own documents and information into the system, as opposed to requiring the user to perform such actions. The client is able to interact with a client-side platform and/or portal and interact with the user (e.g. an accountant user) via the system.

In some embodiments the system is operable to be a multiparty platform where users (e.g. accountants) are able to interact with clients and client documents. Each party can have its own portal and/or platform that they can interact with and each side can be segregated from the others.

Users (both clients and accountants or others) can request and/or send documents, data, and information to each other via the platform. Private note functionality is provided, as is shared note functionality.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for providing an accounting platform, the system comprising:
at least one user computing device in operable connection with a user network;
an application server in operable communication with the user network, the application server configured to host an application system for providing a system for providing an accounting platform, the application system having a user interface module for providing access to the application system through the client computing device, accounting computing device, or subcontractor computing device, the user interface module in operable communication with a user database for storing user information and a document database for storing tax documents; and
a document module to permit the filling and processing of the one or more tax documents;
a portal module to permit the creation of a user portal for interacting with the system.

2. The system of claim 1, further comprising a communications module to permit the communication between the client computing device, the accountant computing device, and the subcontractor computing device.

3. The system of claim 1, wherein the communications module transmits a communication to the client once the portal is set-up by the accountant.

4. The system of claim 1, wherein the communications module transmits a request to complete a Form W-9.

5. The system of claim 4, wherein the document module permits the automated filling of a Form 1099 from the completed Form W-9.

6. A method for providing an accounting platform, the method comprising the steps of:
creating, via a portal module, a portal;
notifying a client of the creation of the portal;
inputting, via the client, subcontractor information;
transmitting a request to a subcontractor to complete a Form W-9;
transmitting the completed W-9 to the client or accountant; and
filling a Form 1099 using the completed Form W-9.

7. A system for providing an accounting platform, the system comprising:
at least one user computing device in operable connection with a user network;
an application server in operable communication with the user network, the application server configured to host an application system for providing a system for providing a client tracking platform, the application system having a user interface module for providing access to the application system through the client computing device, accounting computing device, or subcontractor computing device, the user interface module in operable communication with a user database for storing user information and a document database for storing tax documents; and
a document module to permit the filling and processing of the one or more documents;
a portal module to permit the creation of a user portal for interacting with the system.
